(19) United States
(12) Patent Application Publication
(10) Pub. No.: US 2025/0232106 A1
(43) Pub. Date: Jul. 17, 2025

(54) ADAPTIVE AND INCREMENTAL CIRCUIT DESIGN IMPLEMENTATION

(71) Applicant: Synopsys, Inc., Sunnyvale, CA (US)

(72) Inventors: Sudipto KUNDU, Sunnyvale, CA (US); Vishal KHANDELWAL, Portland, OR (US)

(21) Appl. No.: 18/415,501

(22) Filed: Jan. 17, 2024

(51) Int. Cl. G06F 30/3947; G06N 20/00

(52) U.S. Cl. CPC G06F 30/3947; G06N 20/00

(57) ABSTRACT

Certain aspects of the present disclosure are directed towards a method for circuit design processing. The method generally includes: performing, via a first processing unit, a first stage of a design process for a circuit design; collecting data associated with processing at least a portion of the circuit design via the first processing unit; providing at least a portion of the collected data to a second processing unit to perform a second stage of the design process for at least the portion of the circuit design to yield a circuit processing result; and providing the circuit processing result to the first processing unit to aid in performing the first stage of the design process.

### TECHNICAL FIELD

The present disclosure generally relates to an electronic design automation (EDA) system, and more particularly, to an adaptive and incremental circuit design implementation.

### BACKGROUND

A synthesis operation in electronic design automation refers to the process of transforming a high-level hardware description into a netlist indicating the logical connections and functionality of a circuit. A place and route operation involves mapping the synthesized design onto a physical chip, optimizing (e.g., improving) the placement of components, and defining the routing paths for connectivity. These operations translate a circuit design representation into an electronic circuit design and layout.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects of the present disclosure are directed towards a method for circuit design processing. The method generally includes: performing, via a first processing unit, a first stage of a design process for a circuit design; collecting data associated with processing at least a portion of the circuit design via the first processing unit; providing at least a portion of the collected data to a second processing unit to perform a second stage of the design process for at least the portion of the circuit design to yield a circuit processing result; and providing the circuit processing result to the first processing unit to aid in performing the first stage of the design process.

Certain aspects of the present disclosure are directed towards an apparatus for circuit design processing. The apparatus generally includes a memory and one or more processors coupled to the memory and configured to: perform a first stage of the design process for a circuit design; collect data associated with processing at least a portion of the circuit design via the first processing unit; provide at least a portion of the collected data to a second processing unit to perform a second stage of the design process for at least the portion of the circuit design to yield a circuit processing result; and provide the circuit processing result to the first processing unit to aid in performing the first stage of the design process.

Certain aspects of the present disclosure are directed towards a non-transitory computer-readable medium having instructions stored thereon, than when executed by one or more processors, cause the one or more processors to: perform, via a first processing unit, a first stage of a design process for a circuit design; collect data associated with processing at least a portion of the circuit design via the first processing unit; provide at least a portion of the collected data to a second processing unit to perform a second stage of the design process for at least the portion of the circuit design to yield a circuit processing result; and provide the circuit processing result to the first processing unit to aid in performing the first stage of the design process.

Certain aspects of the present disclosure are directed towards a method for circuit design processing. The method generally includes: performing a first portion of a design process for a circuit design; collecting data associated with processing at least a portion of the circuit design; and training at least one machine learning (ML) model configured to recommend one or more actions to be performed for the design process, wherein the at least one ML model is trained based on the collected data, and wherein a second portion of the design process for the circuit design is performed using the at least one trained ML model.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates example techniques for action recommendation, in accordance with certain aspects of the present disclosure.

FIG. 2 illustrates place and route commands executed in a sequential manner, in accordance with certain aspects of the present disclosure.

FIG. 3 illustrates example components of an intelligent flow system for implementing an intelligent flow, in accordance with certain aspects of the present disclosure.

FIG. 4 is a flow diagram illustrating example operations for circuit design processing, in accordance with certain aspects of the present disclosure.

FIG. 5 illustrates an example set of processes used during the design, verification, and fabrication of an article of manufacture such as an integrated circuit to transform and verify design data and instructions that represent the integrated circuit.

FIG. 6 illustrates an example machine of a computer system within which a set of instructions, for causing the machine to perform any one or more of the methodologies discussed herein, may be executed.

### DETAILED DESCRIPTION

Aspects of the present disclosure relate to adaptive and incremental circuit design implementation. A synthesis and place-and-route implementation system includes flow involving many functional subsystems like synthesis, global and detailed placement, clock-tree synthesis, global and detailed routing and multiple phases of clock and data netlist optimization. These subsystems run in a fixed predefined order for every circuit block. While the flow may be fixed, engines driving the flows are mostly generalized to work safely on a statistically large set of designs. Such approaches create a one-size-fits-all system that does not scale across different circuit blocks.

Tool tuning to hit desired power, performance, and area (PPA) involves multiple expensive iterations that cause significant costs to turnaround time, machine resources, and engineer resources. On top of that, there is negligible harvesting of any knowledge from prior runs of the same or similar blocks, and therefore, every iterative run starts like an unseen design executed with custom manual tuning.

Electronic design automation (EDA) users build a system on chip (SOC) with various circuit blocks tailored for different applications like central processing unit (CPU), graphical processing unit (GPU), networking, and artificial intelligence (AI). Each circuit block may bring a different combination of congestion criticality, differences in clock-tree structure, power criticality, timing criticality, and routing challenges.

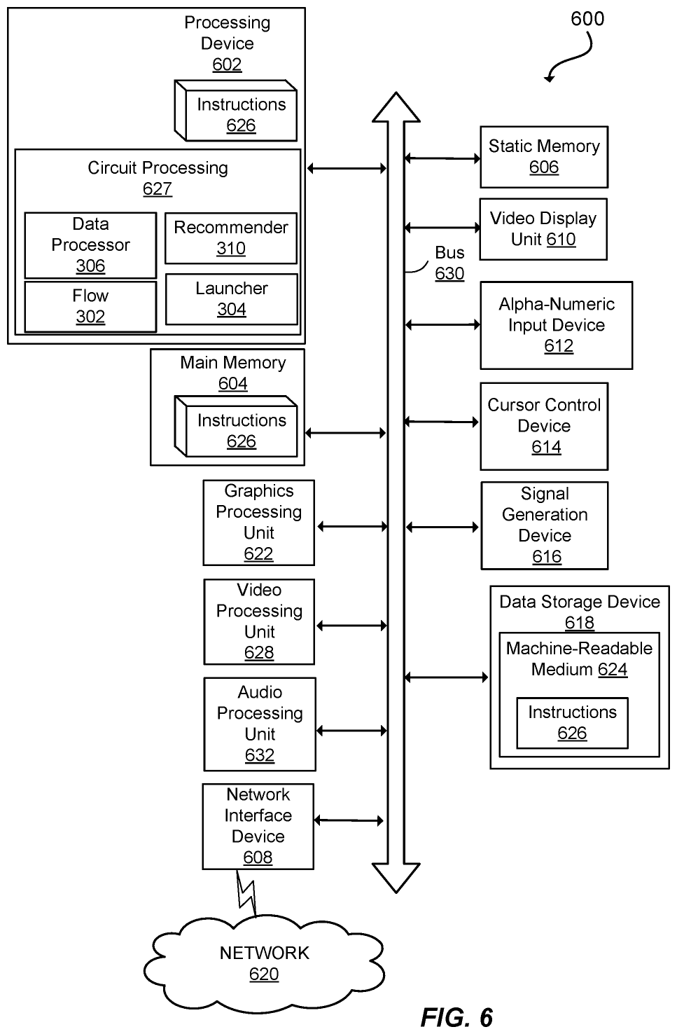

Certain aspects provide a smart self-guided flow component (e.g., corresponding to the circuit processing component 627 of FIG. 6) that performs dynamic decisions along the flow execution to react to the state of the netlist and the characteristics of circuit blocks. From a user standpoint, the tool takes different execution paths for different blocks, and every subsequent run tries to improve from the prior run through continuous learning and understanding of the prior run behavior. Given that computation resources are getting cheaper and more accessible, the tool can leverage parallel learning by looking ahead to downstream challenges through specially engineered subflows, including different functional subsystem interactions.

Certain aspects are directed towards a fully automated self-guided flow component that dynamically explores flow and engine strategies within the tool based on the design characteristics and the current state of flow execution. These dynamic decisions may be within a single synthesis and place-and-route run. Each time a new synthesis and place-and-route run is performed on the same design, the flow may become smarter to leverage the learnings of the prior runs.

Flow component automation may enable learning capability within a single flow run, across multiple iterative runs, and from parallel runs. Certain aspects allow access and retrieval of the learning data through central management of insight storage.

The flow component may store and analyze various health metrics of placement, clock-tree, routing, and optimization subsystems. Health metrics are used to determine how well various synthesis and place-and-route operations, such as placement, CTS, and routing, have been performed. For example, for placement, the metric may include upper and lower layer congestions, pin-density, or wire length. For clock-tree synthesis, the metric may include global latency and global skew per clock, area, and power of clock-tree networks. The metrics may determine the quality of the functional component beyond looking at total negative slack and area/power of the full circuit. In some cases, health and quality may be used interchangeably. Many factors determine the health/quality of each metric area (e.g., placement, CTS, routing, or data path optimization).

Metric anomalies may influence decisions within the same run or the next run. Certain aspects build incremental subsystem iterations to explore, learn, and refine the flow features. For example, whether a design will be routable from the early netlist may be auto-learned by running a small subsystem with the router.

Certain aspects provide a smart self-guided place and route agent automation in the place and route tool to dynamically and intelligently execute runs. To achieve such automation, the tool may build a powerful learning capability within the same run, across multiple single machine runs, or even across parallel multiple machine runs. The system described herein may include a data collection pipeline, a system for learning data patterns, and a flow recommender (e.g., powered by machine learning (ML) models, knowledge database, and rule-based decision models) and a dynamically configurable flow system.

For the data-collection pipeline, there may be information that the engine/flow is generating during normal execution of the place and route flow. There are several opportunities where this data can be used for learning to improve subsequent steps in the flow. This data can be static (e.g., at a specific point in the flow) or dynamic (e.g., trajectory across the flow). For example, placement-related data mining may be used to generate information on local density, density trajectory, congestion hotspots, design rule check (DRC) hotspots, and encode the learning for the next placement run. As another example, information on hard-to-legalize regions, low pass-rate library cells, and other legalization challenges may be generated to drive better placement and legalization convergence. For routing design rule check-related data mining, physical learning of regions having high routing DRC sensitivity may be performed. For data path improvement-related data mining, continuous monitoring of timing and power gradients to compute flow-step power-delay ratio (PDR) may be performed. An encoding tool may be implemented to learn PDR at each step and instance level to automatically drive a power-frugal recipe for the downstream flow (or across runs). Some aspects are directed towards continuous learning of a library cell usage profile based on timing and physical context so that subsequent steps can narrow down to a few targeted library cells based on the knowledge accumulated through prior learning. Some aspects are directed toward tracking a power trajectory to identify power-hungry cones of logic and enable downstream (e.g., for next run) improvements for timing using power-efficient solutions.

Today, place and route tools may lack the capability to accumulate large amounts of data from an active run continuously. In certain aspects of the present disclosure, a flow component may be configured to collect various data at different flow checkpoints (e.g., after the completion of specific predefined operations). For instance, one checkpoint may be after placement and optimization is performed and before clock-tree synthesis is performed. Another checkpoint may be after clock-tree synthesis is performed. At these checkpoints, netlist data may be collected, such as timing endpoint slacks and area/power of clock logic vs data logic.

Such data may continue accumulating for the agent to learn the patterns at a local step or a large mega command level. Once the flow finishes, the learning patterns may be stored in a common insight database to be leveraged in the next run.

Some aspects are directed towards learning data patterns. For example, a flow component may be used to continuously collect netlist properties and logical and physical data at various checkpoints. The agent may be configured to analyze large amounts of data to make meaningful patterns. For example, the agent may collect congestion values per grid of the physical layout. The layout is divided into grids, and each grid may have values related to routing capacity and supply. Once the data is collected, the agent may learn about the hotspot patterns on the layout by running an algorithm to find physically clustered values indicating a high congestion pattern. The agent continuously collects delay and power usage per move during setup fixing and hold fixing steps. At specific checkpoints, the agent analyzes changes in delay and power and generates an outlier region with a bad tradeoff using curve fitting. This outlier region where bad tradeoffs are made may be restricted to downstream flow.

As another example, the agent may collect design timing, endpoint timing distribution, and the number of violating paths at specific checkpoints to learn whether timing specifications are easily met for the design. Various use cases may have different learning techniques depending on the nature of data and how the data can be processed for meaningful action. The learning techniques summarize an enormous collection of data into more condensed form. The agent writes out the learned parameters instead of raw data into an intelligent database to use the learnings for the next run.

Certain aspects provide a flow recommender. During the flow execution, the agent may continuously collect specific data and analyze the data on the fly to make dynamic decisions. The flow recommender may map the analysis to specific decisions to be taken at a certain checkpoint in the flow. The flow recommendation can be a machine learning (ML) model based on pre-training of a large number of designs or may be simple rule-based decisions. Once the agent learns the particular behavior of the flow or engine, the agent can find various recommendations with some confidence score. A low score may indicate that the action should be explored as a trial run through multi-machine exploration and should not be tried in a single-run iteration. A high score may indicate that the agent should dynamically alter the flow execution to take sensible action.

Technical advantages of the present disclosure include, but are not limited to, increased efficiency of computing devices for performing circuit design processing, such as placement and routing operations. For example, by providing dynamic recommendations, actions may be taken that increase the overall efficiency associated with processing a circuit design, as described in more detail herein.

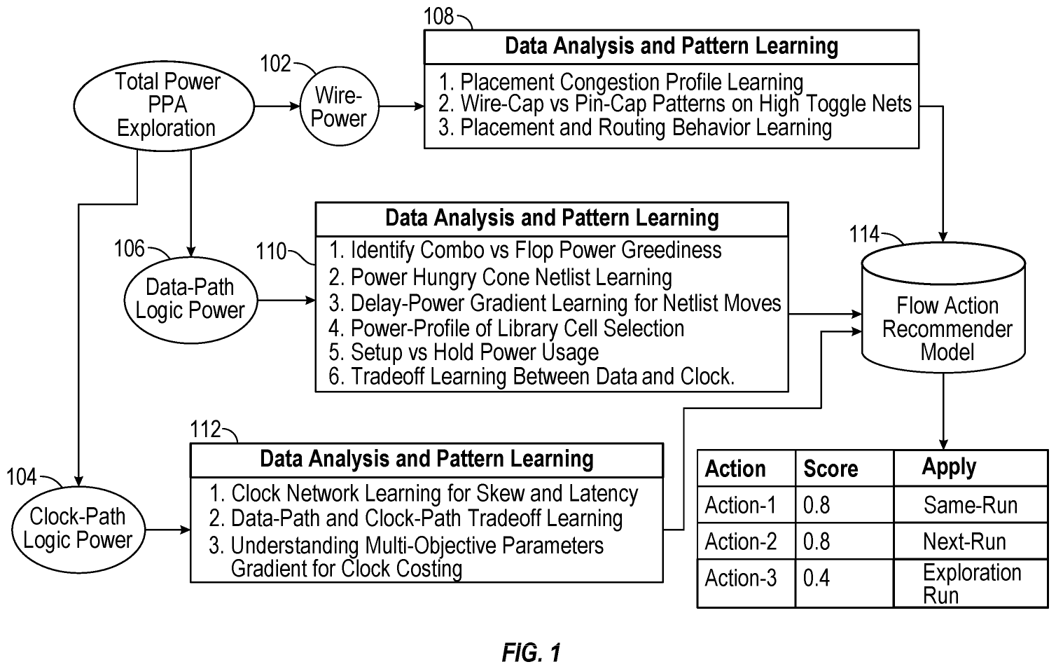

FIG. 1 illustrates example techniques for action recommendation, in accordance with certain aspects of the present disclosure. As shown, the flow component may perform total power and PPA exploration. For instance, to improve a total-power metric, the software agent may be pre-populated with a knowledge graph for the total-power metric. For example, A decision tree may be implemented based on a breakdown of wire power, clock power, and data path logic power. For each branch of the decision tree, a set of actions with confidence scores may be pre-populated when the system boots up. The agent may break the total-power metric (or PPA) metric into different netlist components like wire power 102, clock network power 104 (e.g., clock-path logic power), data path logic power 106 (e.g., power for combination or sequential logic) and for each category, the agent may start data collection and analysis at specific checkpoints in the flow. Such checkpoints may be programmed upfront in the software. For example, if the placement does not show a congestion issue and the timing is not extremely important, the recommender may recommend more aggressive placement clumping as well as controlling timing versus power parameters to reduce wire power. For instance, the flow component may identify whether a number of circuit elements in a region is more than a threshold to determine congestion or determine the available slack to determine whether timing specifications are being met. The flow component may run a global router to determine congestion, and if congestion is not identified, the flow component may not perform cell spreading. The cell spreading statistics indicate whether there is congestion. The presence of a no-congestion hotspot indicates that there is no congestion. For timing, timing convergence may be monitored, and if the timing can be fixed to a single-digit total negative slack (TNS), the timing should be easy to fix, which is taken into account by the recommender to make recommendations.

At block 108, wire power data analysis and pattern learning may be performed. For example, placement congestion profile learning may be performed, wire capacitance and pin capacitance patterns on high toggle nets may be analyzed, and placement and routing behavior learning may be performed. Based on data path logic power, the flow component may determine combinational logic versus flop power greediness, power-hungry cone netlist learning, delay power gradient learning for netlist moves, power profile of library cell selection, setup versus hold power usage, and tradeoff learning between data and clock paths. For example, depending on the netlist structure (e.g., whether logic cones are shallow as may be for a CPU or are wide logic cones as may be for a GPU), the flow component may determine whether to first improve timing using a start point flop, or work on combinational logic-gates. Flops may be power hungry and, in CPU-style shallow cones, the flow component recommends deferring improvement steps of such flops in shallow cones (e.g., for a CPU), while for wide logic cones (e.g., for a GPU), the flow component may recommend improving the logic cones earlier in the process. The learning-based flow component can make these decisions dynamically based on logic cone structures, power activity, and timing criticality data. For power-hungry cone netlist learning, the flow component may recommend holding back on the power-inefficient logic gates, allowing timing violations to be closed (e.g., resolved) by other transforms (e.g., concurrent clock and data (CCD) optimization or placement) as opposed to giving up power in the logic cone optimization. The netlist structure learning is considered by the flow component as power is consumed in the fanout and fanin cones of large and shallow depths. Such learning may differentiate two designs, and the strategy to address such patterns may be determined on the fly by the flow component.

Based on clock path logic power, the flow component may perform clock network learning for skew and latency, data path and clock path tradeoff learning, and determine multi-objective parameters gradient for clock costing. For example, the power cost on a clock tree may be a function of the achieved/desired clock skew and latency of the clock tree. Designs may be clock or data path power heavy, based on which the flow component may determine (e.g., recommend) how much to push clock-tree improvement (e.g., to fix timing issues) versus data path improvement such that the overall design power is reduced and timing specifications are met.

The data analysis and learned patterns may be input to a flow action recommender model 114, which may output several recommended actions (labeled “Action-1”, “Action-2”, and “Action-3”) with associated scores. The recommender model 114 may also indicate whether the action should be applied to the same place and route run, a subsequent place and route run, or an exploration run. If the score is less than some threshold, the action may be recommended for an exploration run for further analysis. For instance, a parallel machine may be used to explore the action further to see if the action should be performed.

The recommender model 114 may be implemented by a processing device (e.g., processing device 602) configured to provide recommendations described herein. The recommendations may be provided in accordance with a recommendation model that may be stored in memory, such as in memory 604 of FIG. 6.

Certain aspects are directed towards subflow exploration. Some aspects provide subflow execution within a limited computing footprint to learn the interaction of different subsystems. As used herein, a subflow generally refers to a separate design processing flow (e.g., separate from a main flow for design processing). In some cases, the main flow may be performed using one processing unit, while a subflow may be performed using another processing unit, allowing the subflow to perform an exploratory design process to assist the main flow. The subflow may be referred to as a lightweight flow in that it may be configured to perform a subset of design process stages aimed at assisting the main flow. The subflow may be performed to identify interactions of different components, providing feedback to the main flow (e.g., feedback indicating convergence in later P&R stages).

A flow may execute big monolithic flow steps one after another like placement, optimization, clock-tree synthesis, and routing in a fixed order. One of the challenges of place and route is understanding if early design decisions and netlist optimization could cause an issue downstream. For example, the placement quality of the netlist may be completely unrouteable downstream, and the user discovers the issue late in the flow, losing significant turnaround time.

Certain aspects are directed towards an on-the-fly small orchestrated subflow including multiple subsystems to detect correlation challenges and the complexity of the block in terms of floorplan, routing resources, and improvement constraints. The flow component may launch multiple subflows and accumulate learning from these parallel executions. The flow component may task some sub-flows to build machine learning (ML) models and train the models on the side with additional computing resources. Each subflow may generate a model for a particular application. For example, one model may be generated for predicting endpoint slack after clock tree synthesis during the pre-clock-tree synthesis stage.

The models may be used in the next run to provide better accuracy over the estimations at the early part of the flow. For example, clock transition data from post clock-tree synthesis step can allow the building of a model that predicts clock transition per clock to drive the early part of the flow that runs in a desired clock environment.

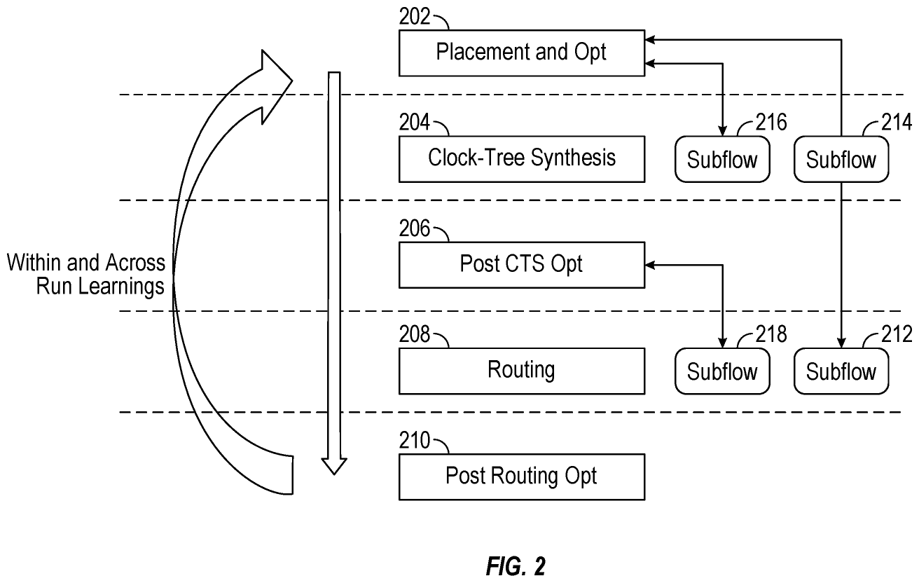

FIG. 2 illustrates place and route commands executed in a sequential manner, in accordance with certain aspects of the present disclosure. The intelligent flow component may create small subflows that exercise multiple downstream components and provide a look-ahead prediction of the netlist challenge. These subflows break the boundaries of fixed mega-command partitions and explore interactions that can be exploited early in the flow.

As shown, at 202, placement and optimization operations may be performed, followed by clock-tree synthesis (CTS) operations at 204, followed by post-CTS optimization at 206, followed by touring at 208, and followed by post-routing optimization at 210. In some aspects, subflows may auto-detect correlation challenges across place and route subsystems. For instance, at 202, placement operations may be performed. Once the placement of components from a particular circuit block is completed, one or more subflows may be performed in parallel. For instance, a first machine may be used to perform the main flow (e.g., perform the placement at 202), while a second machine may be operated to run a subflow 212 in routing to identify whether the placement of the particular circuit block that has completed placement is routable. If not, this information may be indicated to the first machine performing the main flow to adjust the placement of the circuit block. Thus, the second machine may run parallel processes while the first machine performs the main flow (e.g., placement at 202), providing recommendations back to the first machine to implement adjustments. As shown, one or more subflows 214, 216 may be performed in parallel with placement at 202 to identify issues with CTS associated with a circuit block synthesis. For example, at one point during the placement at 202 (e.g., after a first checkpoint), the subflows 214 and 212 may be performed to provide feedback data to assist the placement at 202 and at another point during the placement 202 (e.g., after a second checkpoint), the subflow 216 may be performed to provide other feedback data to assist the placement at 202. The subflows are used for look-ahead exploration to predict what may happen in the future (e.g., in later place and route stages). At 202 for placement and optimization, subflow 216 may predict results during the future stage of clock-tree synthesis and subflows 214, 212 may predict clock-tree synthesis and routing. This information can be used at 202 during placement to make decisions.

Similarly, during post-CTS optimization 206, a subflow 218 may be performed to identify issues with routing. In this manner, the intelligent flow may identify if a netlist can cause a hold timing violation after post-clock-tree synthesis using subflow 218. A series of subflows may be programmed to perform placement, high fanout synthesis, delay optimization, and clock-tree synthesis. The flow component may determine if a circuit block has crosstalk challenges post-detailed routing. The flow component may determine if a clock skew profile is the dominant reason for post-routing timing closure.

Certain aspects are directed towards context-embedding. Context embedding refers to the timing and physical context of each instance and the set of netlist changes happening at each instance. Context embedding may be learned to predict the most likely netlist transformation, such as sizing, buffering, or restructuring. In the flow, different optimization transforms may be analyzed multiple times. Context embedding provides the learning to make adaptive and intelligent decisions about what netlist transforms may be helpful for improving the design. Through analytical or ML techniques, context embedding involves continuously monitoring the context cell and neighborhood. Actions may be defined to be taken on similar context embedding to drive subsequent steps/runs. The tool may include a context cache that can efficiently capture optimization history through signatures (e.g., capturing structural/timing/physical information). Incremental place and route may rely on context information to drive targeted optimization tricks instead of the usual try-and-reject approach. The optimization tricks may include techniques to identify component sizing, buffering, wire sizing, wire-layer-assignment, or a set of logical restructuring transforms (e.g., remapping of logic gates into functional equivalent sets of logic gates with different PPA tradeoffs). The context cache may be in memory but may be periodically refreshed to disk to save the learning for a subsequent run.

In some aspects, the intelligent flow is implemented in a place and route tool. The intelligent flow provides power improvements for circuit designs. The tool may auto-detect anomalies that are time-consuming for tool users to discover. Often tool users may go through extensive log analysis and exploit tribal knowledge base and experience to make many trial and error runs to get the desired PPA. The intelligent flow may automatically infer many PPA anomalies and make scientific decisions.

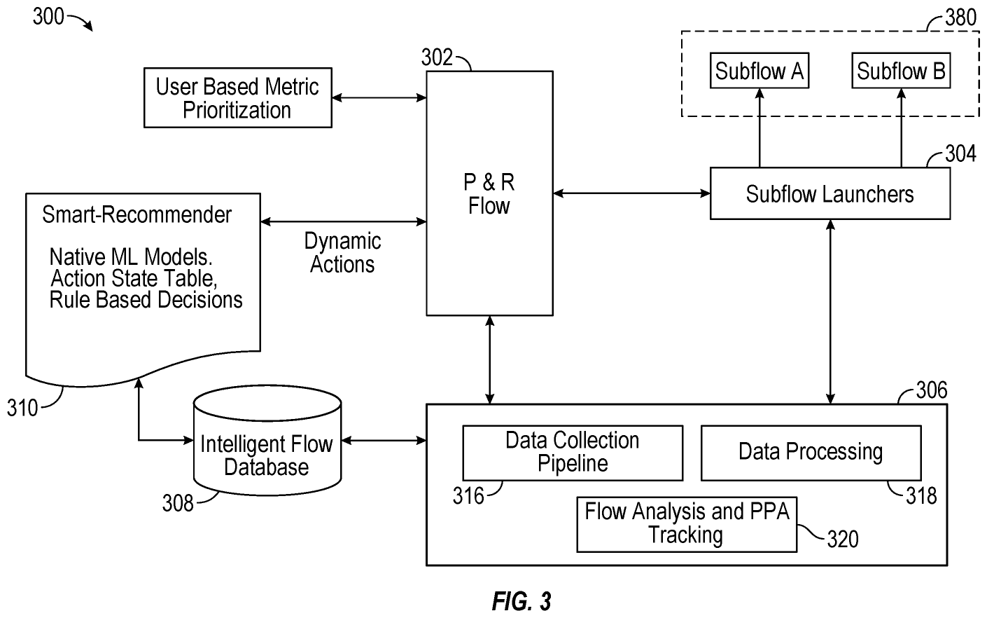

FIG. 3 illustrates example components of an intelligent flow system 300 for implementing an intelligent flow, in accordance with certain aspects of the present disclosure. The intelligent flow system 300 may be implemented with a single machine or multiple machines to facilitate parallel processing. As shown, the system 300 may include a place and route flow (labeled “P&R flow”) component 302 (e.g., a first processing unit for performing P&R) and a data processor 306. During the place and route operation, the data processor 306 may perform data collection (e.g., using a data collection pipeline 316), perform data processing via a processing component 318, and perform flow analysis and PPA tracking using a tracking component 320. For example, pipeline 316 may be used to collect data as synthesis and place and route operations are performed. The data may indicate, for example, congestion data, clock and data path timing data (e.g., slack), data indicating a level of shallowness or wideness of logic cones, wire and pin capacitance data, and clock/data path power consumption data. The collected data may be any design data that can be leveraged for learning (or features for any ML model). This collected data may also include data to train a model or drive learning.

The processing component 318 may analyze the data (e.g., perform the operations described with respect to blocks 108, 110, 112 of FIG. 1). The tracking component 320 may continuously analyze the place and route flow and PPA to determine whether improvements (or degradation) to PPA have occurred based on flow actions. For instance, the tracking component 320 may continuously analyze placement changes of circuit elements to determine improvement (or degradation) of area or path timing. As continuous monitoring of the state of the design is performed, health metrics may be inferred to make decisions. For example, if congestion has degraded beyond a certain threshold, a congestion-recover pass may be performed adaptively to recover that metric. As another example, as certain regions of the design become highly density, a targeted area recovery may be performed to alleviate that utilization pressure.

The data from the data processor 306 may be stored in an intelligence flow database 308. The data from the database 308 may be retrieved by a recommender component 310. The component 310 may be implemented with one or more ML models, one or more actions state tables, and rule-based decisions to recommend actions to be taken by the place and route flow component 302 as described herein. In some aspects, the system 300 may include a subflow launcher 304. The launcher 304 may launch one or more subflows (e.g., to be on one or more parallel machines or processing units 380) to provide feedback to the flow component 302, as described with respect to FIG. 2. In some aspects, the flow component 302 may receive one or more user-based metric prioritization indications to be used during the place and route flow (e.g., one or more metrics that may be prioritized during the operation of the place and route flow).

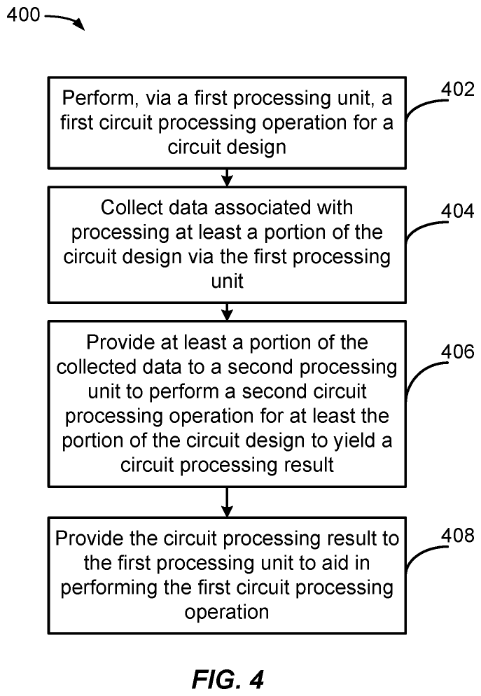

FIG. 4 is a flow diagram illustrating example operations 400 for circuit design processing. The operations 400 may be performed by a processing device, such as the processing device 602 of FIG. 6.

At 402, the processing device may perform, via a first processing unit (e.g., processing unit of the flow component 302 of FIG. 3), a first stage of a design process for a circuit design (e.g., a stage of electronic design automation (EDA), such as routing or placement for the circuit design). At 404, the processing device collects data (e.g., via pipeline 316) associated with processing at least a portion of the circuit design via the first processing unit. At 406, the processing device provides at least a portion of the collected data to a second processing unit (e.g., one or more processing units 380) to perform a second stage of the design process for at least the portion of the circuit design to yield a circuit processing result. For example, the circuit processing result may include an indication of whether placement of circuit elements can be routed efficiently during the routing stage. At 408, the processing device provides the circuit processing result to the first processing unit to aid in performing the first stage of the design process. In some aspects, the second circuit processing operation is performed via the second processing unit while at least a portion of the first stage of the design process is being performed.

In some aspects, the processing device analyzes (e.g., via processing component 318) at least a portion of the collected data and provides a recommendation for an action to be performed when performing one of multiple stages of a place and route flow for the circuit design. In some aspects, the first circuit processing operation is performed during a first stage of the multiple stages of the place and route flow, the action being recommended to be performed during the first stage. In some aspects, the multiple stages are performed during each run of the place and route flow. The data may be collected for a first run of the place and route flow. The action may be recommended to be performed during a stage of a second run of the place and route flow, the second run being different than the first run. In some aspects, the at least the portion of the collected data is analyzed via at least one of one or more machine learning (ML) models, action state table, or rule-based decisions. In some aspects, the processing device may provide an indication of whether the action is recommended to be applied during a current run of the place and route flow, whether the action is recommended to be applied during a subsequent run of the place and route flow, or whether the action is recommended for further analysis during an exploration run of the place and route flow. In some aspects, the processing device may determine a confidence score associated with the recommendation. Confidence score may be determined by collecting flow features and running actions on training designs, which is then used to collect labels (e.g., indicating a good or bad result) based on the final result produced. Then, the model trained on training designs is then run on unseen designs for cross-validation and for accuracy measurement. The confidence score may be a measurement of this accuracy. The action may be recommended based on a comparison of the confidence score with a threshold. In some aspects, analyzing the at least the portion of the collected data may include analyzing at least one of: power consumption associated wiring for the circuit design; power consumption associated data path logic of the circuit design; or power consumption associated clock path logic of the circuit design. In some aspects, the recommendation of the action may include at least one of: a placement recommendation based on analyzing circuit congestion; a recommendation associated with timing of signals for the circuit design, a recommendation based on design rule check (DRC) hotspots for the circuit design; or a recommendation based on identification of power-hungry logic cones of the circuit design.

In some aspects, the first stage of the design process may include a first one of multiple stages of a place and route flow, and the second stage of the design process may include a second one of the multiple stages of the place and route flow. The multiple stages may include a placement and optimization stage, a clock-tree synthesis (CTS) stage, post-CTS optimization stage, routing stage, and post-routing optimization stage.

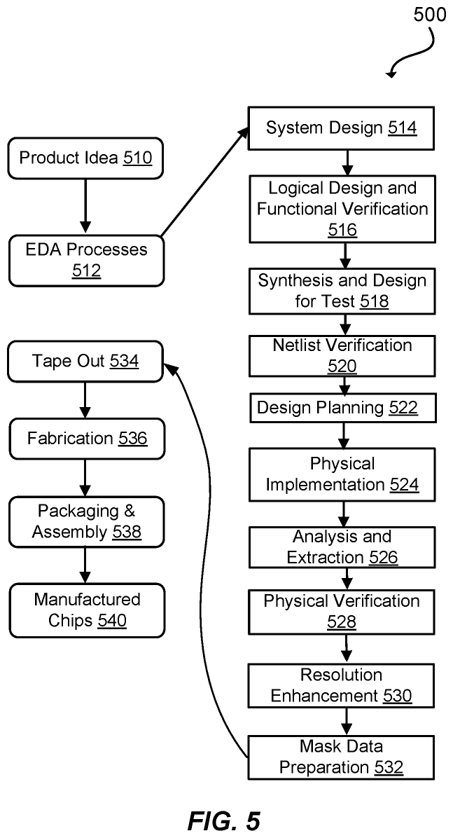

FIG. 5 illustrates an example set of processes 500 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 510 with information supplied by a designer, information which is transformed to create an article of manufacture that uses a set of EDA processes 512. When the design is finalized, the design is taped-out 534, which is when artwork (e.g., geometric patterns) for the integrated circuit is sent to a fabrication facility to manufacture the mask set, which is then used to manufacture the integrated circuit. After tape-out, a semiconductor die is fabricated 536 and packaging and assembly processes 538 are performed to produce the finished integrated circuit 540.

Specifications for a circuit or electronic structure may range from low-level transistor material layouts to high-level description languages. A high-level representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding tools of that layer (e.g., a formal verification tool). The processes described by be enabled by EDA products (or tools).

During system design 514, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 516, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 518, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 520, the netlist is checked for compliance with timing constraints and for correspondence with the HDL code. During design planning 522, an overall floor plan for the integrated circuit is constructed and analyzed for timing and top-level routing.

During layout or physical implementation 524, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flip-flop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 526, the circuit function is verified at the layout level, which permits refinement of the layout design. During physical verification 528, the layout design is checked to ensure that manufacturing constraints are correct, such as DRC constraints, electrical constraints, lithographic constraints, and that circuitry function matches the HDL design specification. During resolution enhancement 530, the geometry of the layout is transformed to improve how the circuit design is manufactured.

During tape-out, data is created to be used (after lithographic enhancements are applied if appropriate) for production of lithography masks. During mask data preparation 532, the ‘tape-out’ data is used to produce lithography masks that are used to produce finished integrated circuits.

A storage subsystem of a computer system (such as computer system 600 of FIG. 6) may be used to store the programs and data structures that are used by some or all of the EDA products described herein, and products used for development of cells for the library and for physical and logical design that use the library.

FIG. 6 illustrates an example machine of a computer system 600 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM), a static memory 606 (e.g., flash memory, static random access memory (SRAM), etc.), and a data storage device 618, which communicate with each other via a bus 630.

Processing device 602 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 may be configured to execute instructions 626 for performing the operations and steps described herein.

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a non-transitory computer-readable medium) on which is stored one or more sets of instructions 626 or software embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In some implementations, the instructions 626 include instructions to implement functionality corresponding to the present disclosure. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 602 to perform any one or more of the methodologies of the present disclosure. The term “machine-readable storage medium” shall accordingly be taken to include, but not be limited to, solid-state memories, optical media, and magnetic media.

In some aspects of the present disclosure, the processing device 602 may include a circuit processing component 627, which may be configured to perform various circuit design improvement tasks, such as clock skewing, and data path improvement. The circuit processing component 627 may include the flow component 302, the data processor 306, the recommender component 310, and launcher 304, as described in FIG. 3.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method for circuit design processing, comprising:
performing, via a first processing unit, a first stage of a design process for a circuit design;
collecting data associated with processing at least a portion of the circuit design via the first processing unit;
providing at least a portion of the collected data to a second processing unit to perform a second stage of the design process for at least the portion of the circuit design to yield a circuit processing result; and
providing the circuit processing result to the first processing unit to aid in performing the first stage of the design process.

2. The method of claim 1, wherein the second stage of the design process is performed via the second processing unit while at least a portion of the first stage of the design process is being performed.

3. The method of claim 1, further comprising:
analyzing at least a portion of the collected data; and
providing a recommendation for an action to be performed when performing one of multiple steps of a place and route flow for the circuit design.

4. The method of claim 3, wherein the first stage of the design process is performed during a first step of the multiple steps of the place and route flow, the action being recommended to be performed during the first step.

5. The method of claim 3, wherein the multiple steps are performed during each run of the place and route flow, wherein the data being collected for a first run of the place and route flow, and wherein the action is recommended to be performed during a step of a second run of the place and route flow, the second run being different than the first run.

6. The method of claim 3, wherein the at least the portion of the collected data is analyzed via at least one of one or more machine learning (ML) models, action state table, or rule-based decisions.

7. The method of claim 3, further comprising providing an indication of whether the action is recommended to be applied during a current run of the place and route flow, whether the action is recommended to be applied during a subsequent run of the place and route flow, or whether the action is recommended for further analysis during an exploration run of the place and route flow.

8. The method of claim 3, further comprising determining a confidence score associated with the recommendation, wherein the action is recommended based on a comparison of the confidence score with a threshold.

9. The method of claim 3, wherein analyzing the at least the portion of the collected data comprising analyzing at least one of:
power consumption associated with wiring for the circuit design;
power consumption associated with data path logic of the circuit design; or
power consumption associated with clock path logic of the circuit design.

10. The method of claim 3, wherein the recommendation of the action comprises at least one of:
a placement recommendation based on analyzing circuit congestion;
a recommendation associated with timing of signals for the circuit design;
a recommendation based on design rule check (DRC) hotspots for the circuit design; or
a recommendation based on identification of power-hungry logic cones of the circuit design.

11. The method of claim 1, wherein the first stage of the design process comprises a first one of multiple stages of a place and route flow, and wherein the second stage of the design process comprises a second one of the multiple stages of the place and route flow.

12. The method of claim 11, wherein the multiple stages comprise one or more of a placement and optimization stage, a clock-tree synthesis (CTS) stage, post-CTS optimization stage, routing stage, and post-routing optimization stage.

13. An apparatus for circuit design processing, comprising:
a memory; and
one or more processors coupled to the memory and configured to:
perform, via a first processing unit, a first stage of a design process for a circuit design;
collect data associated with processing at least a portion of the circuit design via the first processing unit;
provide at least a portion of the collected data to a second processing unit to perform a second stage of the design process for at least the portion of the circuit design to yield a circuit processing result; and
provide the circuit processing result to the first processing unit to aid in performing the first stage of the design process.

14. The apparatus of claim 13, wherein the second stage of the design process is performed via the second processing unit while at least a portion of the first stage of the design process is being performed.

15. The apparatus of claim 13, wherein the one or more processors are configured to:
analyze at least a portion of the collected data; and
provide a recommendation for an action to be performed when performing one of multiple steps of a place and route flow for the circuit design.

16. The apparatus of claim 15, wherein the multiple steps are performed during each run of the place and route flow, wherein the data being collected for a first run of the place and route flow, and wherein the action is recommended to be performed during a step of a second run of the place and route flow, the second run being different than the first run.

17. The apparatus of claim 15, wherein the one or more processors are further configured to provide an indication of whether the action is recommended to be applied during a current run of the place and route flow, whether the action is recommended to be applied during a subsequent run of the place and route flow, or whether the action is recommended for further analysis during an exploration run of the place and route flow.

18. A method for circuit design processing, comprising:
performing a first portion of a design process for a circuit design;
collecting data associated with processing at least a portion of the circuit design; and
training at least one machine learning (ML) model configured to recommend one or more actions to be performed for the design process, wherein the at least one ML model is trained based on the collected data, and wherein a second portion of the design process for the circuit design is performed using the at least one trained ML model.

19. The method of claim 18, wherein the first portion of the design process comprises a first run of the design process, and wherein the second portion of the design process comprises a second subsequent run of the design process.

20. The method of claim 18, wherein:
the first portion of the design process is performed via a first processing unit and includes a first stage of the design process;
the method further comprises providing at least a portion of the collected data to a second processing unit to perform a second stage of the design process for at least the portion of the circuit design to generate a circuit processing result; and
the at least one ML model is trained using the circuit processing result generated via the second processing unit.
